(19) United States
(12) Patent Application Publication
(10) Pub. No.: US 2025/0356233 A1
(43) Pub. Date: Nov. 20, 2025

(54) QUANTUM COMPUTING PLATFORM

(71) Applicant: KOREA UNIVERSITY RESEARCH AND BUSINESS FOUNDATION, Seoul (KR)

(72) Inventors: Zang-Hee CHO, Hwaseong-si, Gyeonggi-do (KR); Haigun LEE, Seoul (KR); Dae-Hwan SUK, Seoul (KR)

(21) Appl. No.: 18/868,724

(22) PCT Filed: Apr. 21, 2023
(86) PCT No.: PCT/KR2023/005441

§ 371 Date: Jul. 28, 2025

(30) Foreign Application Priority Data
May 23, 2022 (KR) 10-2022-0062508
Jul. 28, 2022 (KR) 10-2022-0093630

(51) Int. Cl. G06N 10/40

(52) U.S. Cl. CPC G06N 10/40

(57) ABSTRACT

According to some exemplary embodiments of the present disclosure, disclosed is a quantum computing platform, which may include: a magnet having a space formed therein; a bar inserted into an interior of the magnet, and containing a material capable of state transition; a gradient coil provided inside the magnet and generating a gradient inside the magnet; a first RF coil placed between the bar and the gradient coil, and applying a first radio frequency (RF) pulse to the interior of the magnet; and at least one second RF coil placed between the bar and the first RF coil, applying a second RF pulse to the interior of the magnet, and generating a qubit by using the bar. A selected figure may be FIG. 1.

### TECHNICAL FIELD

The present disclosure relates to a quantum computing platform, and more particularly, to a quantum computing platform for generating a qubit.

### BACKGROUND OF THE INVENTION

A quantum computer can be a computer that processes data by using phenomena related to quantum mechanics such as quantum entanglement, quantum superposition, etc. The quantum entanglement can mean a state in which two or more states are quantumly connected to each other, so that they cannot be handled separately in each state. The quantum superposition can mean that various result states by measurement are simultaneously present probabilistically before measuring the quantum state. The quantum computer can use a qubit as a basic unit of information for processing data by using a phenomenon related to the quantum mechanics.

The qubit may simultaneously express values corresponding to various bits by using the quantum superposition state. For example, the qubit may express respective values as probabilities such as ‘0 with a probability of 20% and 1 with a probability of 80%’. The qubit can be determined as one state while the quantum superposition state is released when being observed.

A driving scheme for generating the qubit can be referred to as a platform of the quantum computer. The platform of the quantum computer can be selected from various types of driving modes, including superconductors, semiconductors, magnets, diamonds, atoms, and ions. However, modes used in existing quantum computer platforms can be difficult to generate qubits because ultra-low temperatures and high vacuum conditions are required pre-emptively. As a document related thereto, Korean Patent Unexamined Publication No. 10-2022-0031998 (published on Mar. 15, 2022) is contrived.

### DISCLOSURE

### Technical Problem

The present disclosure is contrived in response to the above-described background art, and has been made in an effort to provide a quantum computing platform.

Technical objects of the present disclosure are not restricted to the technical object mentioned above. Other unmentioned technical objects will be apparently appreciated by those skilled in the art by referencing the following description.

### Technical Solution

In order to achieve the object described above, an exemplary embodiment of the present disclosure provides a quantum computing platform, which may include: a magnet having a space formed therein; a bar inserted into an interior of the magnet, and containing a material capable of state transition; a gradient coil provided inside the magnet and generating a gradient inside the magnet; a first RF coil placed between the bar and the gradient coil, and applying a first radio frequency (RF) pulse to the interior of the magnet; and at least one second RF coil placed between the bar and the first RF coil, applying a second RF pulse to the interior of the magnet, and generating a qubit by using the bar.

Alternatively, the material may contain a nuclide having a nuclear spin of ½.

Alternatively, the material may include a hydrogen atomic nucleus.

Alternatively, the first RF pulse and the second RF pulse may have different angles.

Alternatively, when there are a plurality of second RF coils, the plurality of second RF coils may be placed to be spaced apart from each other.

Alternatively, the plurality of second RF coils may be placed to be spaced apart from each other to correspond to a predetermined distance.

Alternatively, when there are a plurality of second RF coils, the plurality of second RF coils may have different frequencies from each other.

Alternatively, when there are the plurality of second RF coils, each of the plurality of second RF coils may generate the qubit.

Alternatively, the qubit may determine a probability of each of a ‘0’ state and a ‘1’ state based on a selected time.

Alternatively, the ‘0’ state may correspond to an equilibrium state of the material, and the ‘1’ state may correspond to an excited state of the material.

Alternatively, the qubit may be a signal generated according to a spin echo phenomenon that is expressed when the second RF pulse at a different angle from the first RF pulse is applied to the bar from at least one second RF coil.

Alternatively, the first RF pulse may have an angle of 90 degrees, and the second RF pulse may have an angle of 180 degrees.

In order to achieve the object described above, another exemplary embodiment of the present disclosure provides a method for generating a qubit, which may include: by a first RF coil placed between a bar inserted into an interior of a magnet having a space formed therein and a gradient coil generating a gradient inside the magnet, applying a first RF pulse to the interior of the magnet; and by a second RF coil placed between the bar and the first RF coil, applying a second RF pulse to the interior of the magnet and generating a qubit by using the bar.

### Advantages Effects

According to an exemplary embodiment of the present disclosure, a quantum computing platform can be provided in an efficient mode.

Effects which can be acquired in the present disclosure are not limited to the aforementioned effects and other unmentioned effects will be clearly understood by those skilled in the art from the following description.

### DESCRIPTION OF DRAWINGS

Various aspects are now described with reference to the drawings and like reference numerals are generally used to designate like elements. In the following exemplary embodiments, for purposes of explanation, numerous specific details are set forth to provide a comprehensive understanding of one or more aspects. However, it will be apparent that the aspect(s) can be executed without the detailed matters.

FIG. 1 is a diagram illustrating a quantum computing platform according to some exemplary embodiments of the present disclosure.

FIG. 2 is a diagram illustrating a process of generating a qubit in the quantum computing platform according to some exemplary embodiments of the present disclosure.

FIG. 3 is a diagram for describing a spin echo generated during a process of generating the qubit in the quantum computing platform according to some exemplary embodiments of the present disclosure.

FIG. 4 is a diagram illustrating a method for generating a qubit through a quantum computing platform according to some exemplary embodiments of the present disclosure.

FIG. 5 illustrates a simple and general schematic diagram of an exemplary computing environment in which the exemplary embodiments of the present disclosure may be implemented.

### DETAILED DESCRIPTION OF THE INVENTION

Various exemplary embodiments will now be described with reference to drawings. In this specification, various descriptions are presented to provide appreciation of the present disclosure. However, it is apparent that the exemplary embodiments can be executed without the specific description.

“Component”, “module”, “system”, and the like which are terms used in the specification refer to a computer-related entity, hardware, firmware, software, and a combination of the software and the hardware, or execution of the software. For example, the component may be a procedure executed on a processor, the processor, an object, an execution thread, a program, and/or a computer, but is not limited thereto. For example, both an application executed in a computing device and the computing device may be the components. One or more components may reside within the processor and/or an execution thread. One component may be localized in one computer. One component may be distributed between two or more computers. Further, the components may be executed by various computer-readable media having various data structures, which are stored therein. The components may perform communication through local and/or remote processing according to a signal (for example, data transmitted from another system through a network such as the Internet through data and/or a signal from one component that interacts with other components in a local system and a distribution system) having one or more data packets, for example.

In addition, the term “or” is intended to mean not exclusive “or” but implicit “or”. That is, when not separately specified or not clear in terms of a context, a sentence “X uses A or B” is intended to mean one of the natural inclusive replacements. That is, the sentence “X uses A or B” may be applied to any of the case where X uses A, the case where X uses B, or the case where X uses both A and B. Further, it should be understood that the term “and/or” used in this specification designates and includes all available combinations of one or more items among enumerated related items.

Further, it should be appreciated that the term “comprise” and/or “comprising” means presence of corresponding features and/or components. However, it should be appreciated that the term “comprises” and/or “comprising” means that presence or addition of one or more other features, components, and/or a group thereof is not excluded. Further, when not separately specified or it is not clear in terms of the context that a singular form is indicated, it should be construed that the singular form generally means “one or more” in this specification and the claims.

In addition, the term “at least one of A or B” should be interpreted to mean “a case including only A”, “a case including only B”, and “a case in which A and B are combined”.

Those skilled in the art need to recognize that various illustrative logical blocks, configurations, modules, circuits, means, logic, and algorithm steps described in connection with the exemplary embodiments disclosed herein may be additionally implemented as electronic hardware, computer software, or combinations of both sides. To clearly illustrate the interchangeability of hardware and software, various illustrative components, blocks, constitutions, means, logic, modules, circuits, and steps have been described above generally in terms of their functionalities. Whether the functionalities are implemented as the hardware or software depends on a specific application and design restrictions given to an entire system. Skilled artisans may implement the described functionalities in various ways for each particular application. However, such implementation decisions should not be interpreted as causing a departure from the scope of the present disclosure.

The description of the presented exemplary embodiments is provided so that those skilled in the art of the present disclosure use or implement the present disclosure. Various modifications to the exemplary embodiments will be apparent to those skilled in the art. Generic principles defined herein may be applied to other exemplary embodiments without departing from the scope of the present disclosure. Therefore, the present disclosure is not limited to the exemplary embodiments presented herein. The present disclosure should be analyzed within the widest range which is coherent with the principles and new features presented herein.

In the present disclosure, terms represented by N-th such as first, second, or third are used for distinguishing at least one entity. For example, entities expressed as first and second may be the same as each other or different from each other.

A quantum computing platform in the present disclosure may include a driving mode for generating a qubit. As another example, the quantum computing platform may also include a device or a structure for generating the qubit.

In the present disclosure, generating the qubit may refer to generating quantum bits which may have both states of 0 and 1.

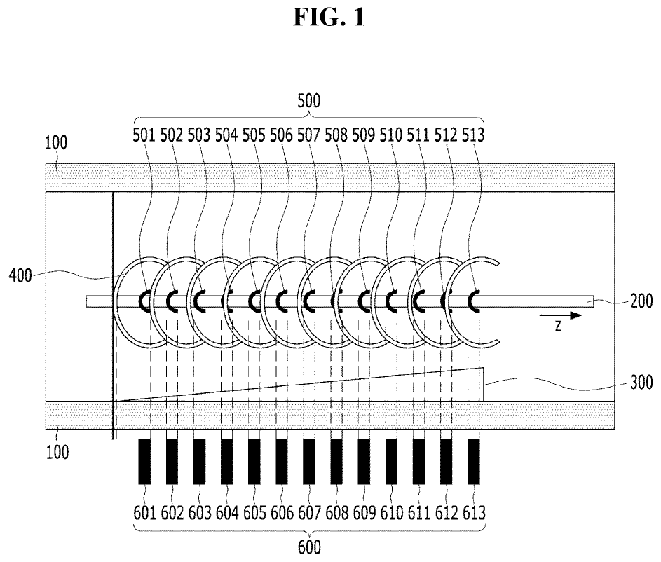

FIG. 1 is a diagram illustrating a quantum computing platform according to some exemplary embodiments of the present disclosure.

Referring to FIG. 1, the quantum computing platform may include a magnet 100, a bar 200, a gradient coil 300, a first radio frequency (RF) coil 400, at least one second RF coil 500, and/or at least one qubit 600.

A configuration of the quantum computing device illustrated in FIG. 1 is only an example showing a cross section through simplification. In an exemplary embodiment of the present disclosure, the quantum computing platform may include other components for generating a qubit, and only some of the disclosed components may also constitute the quantum computing platform.

The magnet 100 is an object that generates a magnetic field and may have a form in which a space is formed inside. For example, the magnet 100 has a cylindrical shape, and the space may be formed in a longitudinal direction (e.g., in a z-axis direction). Accordingly, the bar 200, the gradient coil 300, the first RF coil 400, and at least one second RF coil 500 may be provided inside the magnet 100. Air may be present inside the magnet 100 or an interior of the magnet 100 may be in a vacuum state. However, the type of magnet is not limited thereto and may include various types. The type of magnet 100 may include a permanent magnet, a superconducting magnet, a high temperature superconducting magnet, etc. However, the type of magnet 100 is not limited thereto and may include various magnets generating a magnetic field. A magnetic flux density of the magnet 100 may be in the range of 3.0 T to 11.7 T. A frequency corresponding thereto may be 150 MHz to 500 MHz. However, the magnetic flux density and the frequency of the magnet 100 are not limited thereto and may include various magnetic flux densities and frequencies.

The bar 200 may include a material capable of state transition into a rod form and a hollow tube form. For example, when the bar 200 is the rod form, the bar 200 may be made of a material capable of state transition. As another example, when the bar 200 is the tube form, the bar 200 may include the material state transition inside the tube. However, the form of the bar is not limited thereto and may include various forms.

The material may contain a nuclide having a nuclear spin of ½. The material may contain a hydrogen atomic nucleus. The substance may include ¹H, ¹³C, ³¹P, etc.

The nuclear spin may mean any angular momentum of an atomic nucleus. The nuclear spin may be formed by combining a spin and an orbital angular momentum of any nucleon. The nucleon may be an elementary particle that constitutes the atomic nucleus. The nucleus may include a proton and/or a neutron.

The nuclide may be a nucleus or a type of atom with a unique atomic number and a mass number. The atomic nucleus may mean a part which shows a positive charge and is located at the center of an atom. The atom may mean an elementary particle that constitutes the material.

The bar 200 may be inserted into the interior of the magnet 100. For example, the bar 200 may be inserted in a longitudinal direction (e.g., in a z-axis direction) of the magnet 100, and disposed inside the magnet 100. The bar 200 may be rotated or non-rotated around a longitudinal axis (e.g., a Z-axis). A property of the material included in the bar 200 may include one of gas, liquid, and/or solid.

The gradient coil 300 may be provided inside the magnet 100 and may generate a gradient inside the magnet 100. For example, the gradient coil 300 may be located on an inner wall of the magnet 100.

The gradient coil 300 may generate a gradient in which a strength of the magnetic field linearly changes on at least one of the x-axis, y-axis, and/or z-axis. For example, the gradient coil 300 may generate a gradient in which the strength of the magnetic field linearly changes on at least one of the x-axis, y-axis, and/or z-axis. As an example, the gradient coil 300 may generate the gradient on the z-axis. In this case, the strength of the magnetic field may increase linearly on the z-axis. Accordingly, the atomic nuclei contained in the material of the bar 200 located corresponding to the z-axis inside the magnet 100 may generate signals having different frequencies.

The gradient may be acquired by dividing a change amount of the magnetic field by a change amount of a distance. The gradient may be generated when there are magnetic fields having different magnitude and direction between two points.

The gradient coil 300 illustrated in FIG. 1 may represent a linear increase in the strength of the magnetic field through the gradient. Accordingly, a cross-section of the gradient coil 300 may not be in a form that increases linearly in the z-axis direction, but rather in a form in which a height is constantly maintained in the z-axis direction. However, the form of the gradient coil 300 is not limited thereto.

The first RF coil 400 is placed between the bar 200 and the gradient coil 300 to apply a first radio frequency (RF) pulse to the interior of the magnet. The first RF pulse may be a carrier of a first RF amplitude-modulated by a pulse. The carrier may be a reference waveform used to modulate a data signal.

The first RF coil 400 may have an angle within a range of 0 to 360 degrees. For example, the first RF coil 400 may have an angle of 90 degrees.

A form of the first RF coil 400 may be spiral. However, the form of the first RF coil 400 is not limited thereto, and may include various forms for applying the first RF pulse to the bar 200.

The material of the first RF coil 400 may be a metal for applying the RF pulse, for example, copper. However, the material of the first RF coil 400 is not limited thereto.

At least one second RF coil 500 is placed between the bar 200 and the first RF coil 400 to apply a second RF pulse to the interior of the magnet 100.

The second RF pulse may be a carrier of the second RF amplitude-modulated by the pulse.

The second RF coil 500 may have an angle within a range of 0 to 360 degrees. For example, the second RF coil 500 may have an angle of 180 degrees. The first RF pulse generated by the first RF coil 400 and the second RF pulse generated by the second coil 500 may have different angles.

A form of the second RF coil 500 may be a ring form. Therefore, the second RF coil 500 may have a form of surrounding an outer circumferential surface of the bar 200. However, the form of the second RF coil 500 is not limited thereto, and may include various forms for applying the second RF pulse to the bar 200.

The material of the second RF coil 500 may be a metal for applying the RF pulse, for example, copper. However, the material of the second RF coil 500 is not limited thereto.

When there are a plurality of second RF coils 500, a plurality of second RF coils 501 to 513 may be placed to be spaced apart from each other.

For example, the plurality of second RF coils 501 to 513 may be placed to be spaced apart from each other to correspond to a predetermined distance (e.g., 10 cm, 20 cm, etc.). The predetermined distance may be predetermined based on the number of the plurality of second RF coils 501 to 513 and a length of the bar 200.

For example, the predetermined distance may be a value acquired by dividing the length of the bar 200 by the number of plurality of second RF coils 501 to 513. As another example, the plurality of second RF coils 501 to 513 may be placed to be spaced apart from each other with different spacings between the plurality of second RF coils 501 to 513. The spacing between the plurality of second RF coils 501 to 513 may be selected randomly.

At least one second RF coil 500 may generate at least one qubit 600 by using the bar 200.

When there are a plurality of second RF coils 500, the plurality of second RF coils 501 to 513 may generate qubits 601 to 613, respectively.

The qubit 600 may simultaneously express values corresponding to various bits by using a quantum superposition state. For example, the qubit 600 may express respective values as probabilities such as ‘0 with a probability of 20% and 1 with a probability of 80%’. The qubit may be determined as one state while the quantum superposition state is released when being observed.

The qubit 600 may be a signal generated according to a spin echo phenomenon that is expressed when the second RF pulse at a different angle from the first RF pulse is applied to the bar 200 from at least one second RF coil 500. Here, the first RF pulse and the second RF pulse may have different angles. As an example, the first RF pulse and the second RF pulse may contain signals that have a difference of 90 degrees. As an example, the first RF pulse may have an angle of 90 degrees, and the second RF pulse may have an angle of 180 degrees.

The spin echo may refer to an echo signal that is generated after a certain amount of time has passed when pulses of different angles are applied to spins, respectively in a spin magnetic resonance of electrons or nuclei. For example, the spin echo may be an echo signal generated after a certain period of time by sequentially applying 90-degree and 180-degree pulses to the spin of hydrogen nuclei (included in the material of the bar 200) generated by the magnetic field of the magnet 100 and/or the gradient of the gradient coil 300.

Specifically, the spins may be aligned by a Zeeman effect. The Zeeman effect may mean aligning spins by the magnetic field of the magnet 100 and/or the gradient of the gradient coil 300, and aligning some of the spins in the same direction (+) and other some of the spins in the opposite direction (−) depending on the strength of the magnetic field and/or the gradient. The spins aligned in the same direction (+) or the opposite direction (−) may have different energies.

When the first RF pulse of 90 degrees is applied to the atomic nucleus (spin) of a material included in a bar 200 while the atomic nucleus (spin) is aligned by the Zeeman effect, the atomic nucleus (spin) may be placed in a horizontal direction on an X-Y plane. Next, when the second RF pulse of 180 degrees is applied to the nucleus (spin) through the second coil 500, a spin echo phenomenon may occur. The signal generated by the spin echo phenomenon may be detected by the qubit 600.

The qubit 600 may determine the probability of each of the ‘0’ state and the ‘1’ state based on a selected time. The ‘0’ state may correspond to the equilibrium state of the material, and the ‘1’ state may correspond to the excited state of the material. Below, for convenience of explanation, an example of a method in which the qubit 600 is implemented in the state of 0 and the state of 1 is described. As another example, depending on an implementation aspect, the qubit 600 may be implemented with probabilities for states corresponding to any two values between 0 and 1. As yet another example, depending on the implementation aspect, the qubit 600 may also be implemented with probabilities for each of three or more states.

An equilibrium state may be a state in which no change in material appears to occur, and may be a state of low energy.

An excited state may be a state in which the material absorbs energy and an energy level rises may be a state having high energy. A material in the excited state may be changed to the equilibrium state while releasing energy.

According to some exemplary embodiments of the present disclosure, the quantum computing platform may include a controller. The controller may include a chip, a microchip, etc., for controlling a plurality of components of the quantum computing platform. For example, at least one of the plurality of components of the quantum computing platform may be present on the controller. As another example, the plurality of components of the quantum computing platform may also be present apart from the controller.

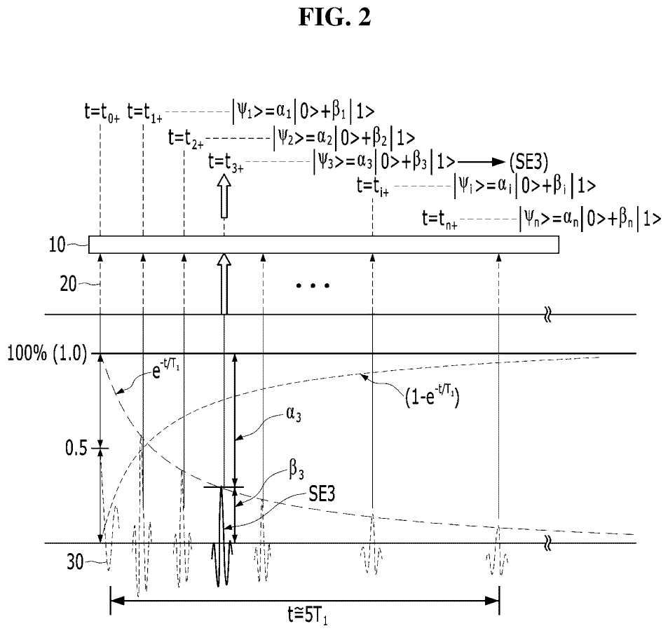

The controller may include a logic gate connected to the qubit 600 and processing information generated by the qubit 600. The logic gate may include a quantum logic gate. The controller may receive data from the qubit 600 at a predetermined time, and adjust the probability of each of the ‘0’ state and the ‘1’ state of the qubit 600. A detailed description thereof will be described below with reference to FIG. 2.

FIG. 2 is a diagram illustrating a process of generating a qubit in the quantum computing platform according to some exemplary embodiments of the present disclosure. Specifically, FIG. 2 is a diagram illustrating a process of generating one qubit 601 in one second RF coil 501 among the plurality of second RF coils 501 to 513 of the quantum computing platform according to some exemplary embodiments of the present disclosure.

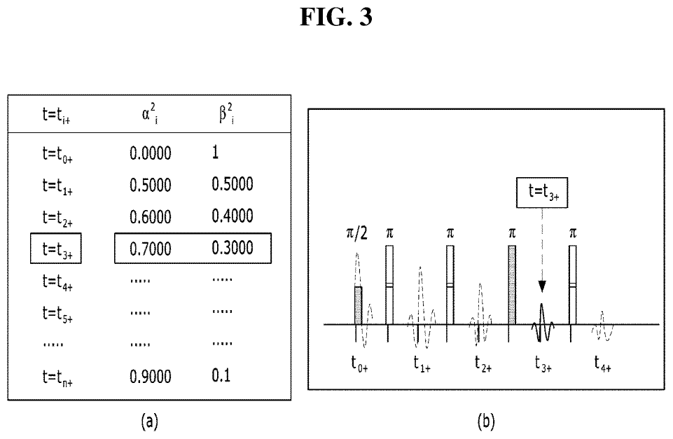

FIG. 3 is a diagram for describing a spin echo generated during a process of generating the qubit in the quantum computing platform according to some exemplary embodiments of the present disclosure. Specifically, FIG. 3A may be a diagram illustrating a probability of each of the ‘0’ state α and the ‘1’ state β of the qubit for each spin echo corresponding to each time. FIG. 3B may be a diagram illustrating the spin echo corresponding to each time. A table and a graph illustrated in FIGS. 3A and 3B may be calculated in advance through an experiment, and prestored in a storage (not illustrated) included in the quantum computing platform.

Referring to FIGS. 2 and 3, the controller 10 including the logic gate may generate the gradient inside the magnet 100 by using the gradient coil 300. And, the controller 10 may apply a first RF pulse (for example, an RF pulse having an angle of 90 degrees) to the interior of the magnet so that the atomic nuclei of the material included in the bar 200 are placed horizontally on the X-Y plane. The controller 10 may cause a spin echo phenomenon to occur by applying a second RF pulse (e.g., an RF pulse having an angle of 180 degrees) to the interior of the magnet. When the spin echo phenomenon occurs, the controller 100 may generate the qubit 601. A time during which the qubit 601 simultaneously has the ‘0’ state α and the ‘1’ state β (quantum superposition) may be during a coherence time. The coherence time may be a time it takes for the nucleus to be placed horizontally on the X-Y plane by the RF pulse and then return to the Z-axis direction. Therefore, the qubit 601 may be used as a computing time that enables quantum processing during the coherence time. In FIG. 2, when the material contains water, T₁ may be 3500 ms and 5T₁ may be 17.5 seconds. Here the computing time may be 17.5 seconds.

The controller 10 may generate the qubit 601 by detecting a spin echo 30 corresponding to a desired encoded time 20. For example, the control unit 10 may determine the state of the qubit 601 and detect the spin echo 30 at the time of the spin echo 30 corresponding to the determined state of the qubit 601 to set the state of the qubit 601 to a desired state.

As an example, when the controller 10 intends to generate a qubit in which a square of the ‘0’ state (α²) is 0.7 and the square of the ‘1’ state (β²) is 0.3, the controller 10 may obtain a time (t=t₃+) corresponding to a qubit in which the square of the ‘0’ state (α²) is 0.7 and the square of the ‘1’ state (β²) is 0.3 through a predetermined time encoded probability amplitudes table (FIG. 3A). And, the controller 10 may confirm and detect a spin echo (SE3) corresponding to the time (t=t₃+) through a spin echo pulse sequence graph (FIG. 3B). The qubit according to the spin echo (SE3) detected here may have the square of the ‘0’ state (α²) of 0.7 and the square of the ‘1’ state (β²) of 0.3.

The plurality of second RF coils 501 to 513 may generate the plurality of qubits 601 to 613, respectively through the process of generating the qubit described according to FIG. 2. For example, the controller 10 may generate at least one qubit using at least one of the plurality of second RF coils 501 to 513. The controller 10 may process information according to a plurality of qubits by connecting the plurality of to the logic gate.

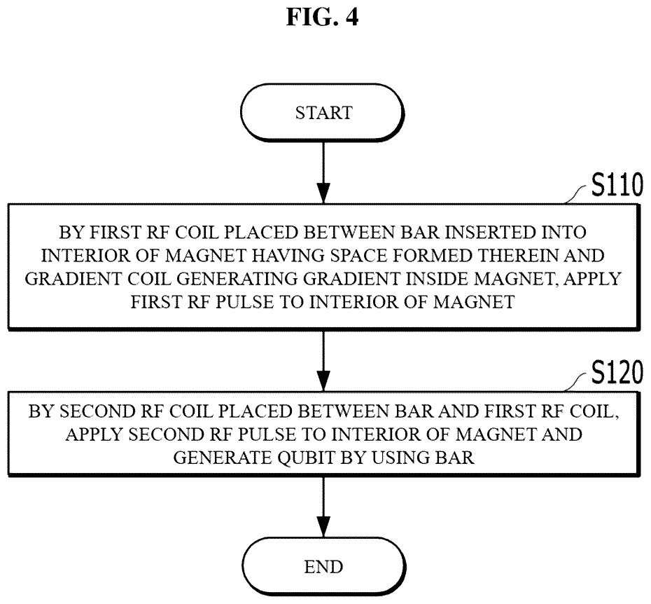

FIG. 4 is a diagram illustrating a method for generating a qubit through a quantum computing platform according to some exemplary embodiments of the present disclosure.

Referring to FIG. 4, the controller controlling the quantum computing platform may apply the first RF pulse to the interior of the magnet 100 by the first RF coil 400 placed in the bar 200 inserted into the interior of the magnet 100 having a space formed therein and the gradient coil 300 that generates the gradient to the interior of the magnet 100 (S110).

Specifically, the controller may form the magnetic field through the magnet 100.

The controller may generate the gradient magnetic field inside the magnet 100 by using the gradient coil 300. And, the controller may apply the first RF pulse (for example, the RF pulse having the angle of 90 degrees) to the interior of the magnet so that the atomic nuclei of the material included in the bar 200 are placed horizontally on the X-Y plane.

The controller may apply the second RF pulse to the interior of the magnet 100 by the second RF coil 500 placed between the bar 200 and the first RF coil 400, and generate the qubit 600 using the bar 200 (S120).

Specifically, the controller 10 may cause the spin echo phenomenon to occur by applying the second RF pulse (e.g., the RF pulse having the angle of 180 degrees) to the interior of the magnet. When the spin echo phenomenon occurs, the controller 100 may generate the qubit 600.

The controller may process information according to the qubit by connecting the generated qubit 600 to the logic gate included in the controller.

Steps illustrated in FIG. 4 are exemplary steps. Therefore, it will also be apparent to those skilled in the art that some of the steps of FIG. 4 may be omitted or there may be additional steps within a range without departing from a spirit scope of the present disclosure. Further, specific contents regarding the components (e.g., the components of the quantum computing platform) disclosed in FIG. 4 may be replaced with the contents described through FIGS. 1 to 3 above.

The quantum computing platform according to some exemplary embodiments of the present disclosure described above through FIGS. 1 to 4 can be manufactured at room temperature. Therefore, the quantum computing platform according to some exemplary embodiments of the present disclosure can facilitate the generation of the qubit, unlike existing methods that require ultra-low temperature conditions, high vacuum conditions, etc., in advance.

The quantum computing platform according to some exemplary embodiments of the present disclosure can implement multiple qubits simultaneously by generating as many qubits as the number of second RF coils when there are a plurality of second RF coils.

The quantum computing platform according to some exemplary embodiments of the present disclosure has a relatively long coherence time compared to existing quantum computing platforms, so that the computing time is relatively long compared to existing quantum computing platforms, enabling more calculations.

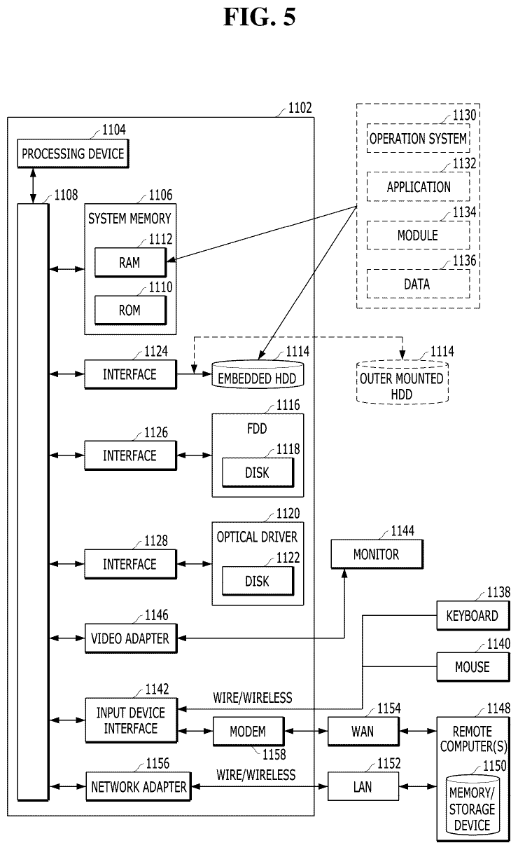

FIG. 5 is a normal and schematic view of an exemplary computing environment in which the exemplary embodiments of the present disclosure may be implemented.

It is described above that the present disclosure may be generally implemented by the computing device, but those skilled in the art will well know that the present disclosure may be implemented in association with a computer executable command which may be executed on one or more computers and/or in combination with other program modules and/or a combination of hardware and software.

In general, the program module includes a routine, a program, a component, a data structure, and the like that execute a specific task or implement a specific abstract data type. Further, it will be well appreciated by those skilled in the art that the method of the present disclosure can be implemented by other computer system configurations including a personal computer, a handheld computing device, microprocessor-based or programmable home appliances, and others (the respective devices may operate in connection with one or more associated devices as well as a single-processor or multi-processor computer system, a mini computer, and a main frame computer.

The exemplary embodiments described in the present disclosure may also be implemented in a distributed computing environment in which predetermined tasks are performed by remote processing devices connected through a communication network. In the distributed computing environment, the program module may be positioned in both local and remote memory storage devices.

The computer generally includes various computer readable media. Media accessible by the computer may be computer readable media regardless of types thereof and the computer readable media include volatile and non-volatile media, transitory and non-transitory media, and mobile and non-mobile media. As a non-limiting example, the computer readable media may include both computer readable storage media and computer readable transmission media. The computer readable storage media include volatile and non-volatile media, transitory and non-transitory media, and mobile and non-mobile media implemented by a predetermined method or technology for storing information such as a computer readable instruction, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.

The computer readable transmission media generally implement the computer readable command, the data structure, the program module, or other data in a carrier wave or a modulated data signal such as other transport mechanism and include all information transfer media. The term “modulated data signal” means a signal acquired by setting or changing at least one of characteristics of the signal so as to encode information in the signal. As a non-limiting example, the computer readable transmission media include wired media such as a wired network or a direct-wired connection and wireless media such as acoustic, RF, infrared and other wireless media. A combination of any media among the aforementioned media is also included in a range of the computer readable transmission media.

An exemplary environment that implements various aspects of the present disclosure including a computer 1102 is shown and the computer 1102 includes a processing device 1104, a system memory 1106, and a system bus 1108. The system bus 1108 connects system components including the system memory 1106 (not limited thereto) to the processing device 1104. The processing device 1104 may be a predetermined processor among various commercial processors. A dual processor and other multi-processor architectures may also be used as the processing device 1104.

The system bus 1108 may be any one of several types of bus structures which may be additionally interconnected to a local bus using any one of a memory bus, a peripheral device bus, and various commercial bus architectures. The system memory 1106 includes a read only memory (ROM) 1110 and a random access memory (RAM) 1112. A basic input/output system (BIOS) is stored in the non-volatile memories 1110 including the ROM, the EPROM, the EEPROM, and the like and the BIOS includes a basic routine that assists in transmitting information among components in the computer 1102 at a time such as in-starting. The RAM 1112 may also include a high-speed RAM including a static RAM for caching data, and the like.

The computer 1102 also includes an interior hard disk drive (HDD) 1114 (for example, EIDE and SATA), in which the interior hard disk drive 1114 may also be configured for an exterior purpose in an appropriate chassis (not illustrated), a magnetic floppy disk drive (FDD) 1116 (for example, for reading from or writing in a mobile diskette 1118), and an optical disk drive 1120 (for example, for reading a CD-ROM disk 1122 or reading from or writing in other high-capacity optical media such as the DVD, and the like). The hard disk drive 1114, the magnetic disk drive 1116, and the optical disk drive 1120 may be connected to the system bus 1108 by a hard disk drive interface 1124, a magnetic disk drive interface 1126, and an optical drive interface 1128, respectively. An interface 1124 for implementing an exterior drive includes at least one of a universal serial bus (USB) and an IEEE 1394 interface technology or both of them.

The drives and the computer readable media associated therewith provide non-volatile storage of the data, the data structure, the computer executable instruction, and others. In the case of the computer 1102, the drives and the media correspond to storing of predetermined data in an appropriate digital format. In the description of the computer readable media, the mobile optical media such as the HDD, the mobile magnetic disk, and the CD or the DVD are mentioned, but it will be well appreciated by those skilled in the art that other types of media readable by the computer such as a zip drive, a magnetic cassette, a flash memory card, a cartridge, and others may also be used in an exemplary operating environment and further, the predetermined media may include computer executable commands for executing the methods of the present disclosure.

Multiple program modules including an operating system 1130, one or more application programs 1132, other program module 1134, and program data 1136 may be stored in the drive and the RAM 1112. All or some of the operating system, the application, the module, and/or the data may also be cached in the RAM 1112. It will be well appreciated that the present disclosure may be implemented in operating systems which are commercially usable or a combination of the operating systems.

A user may input instructions and information in the computer 1102 through one or more wired/wireless input devices, for example, pointing devices such as a keyboard 1138 and a mouse 1140. Other input devices (not illustrated) may include a microphone, an IR remote controller, a joystick, a game pad, a stylus pen, a touch screen, and others. These and other input devices are often connected to the processing device 1104 through an input device interface 1142 connected to the system bus 1108, but may be connected by other interfaces including a parallel port, an IEEE 1394 serial port, a game port, a USB port, an IR interface, and others.

A monitor 1144 or other types of display devices are also connected to the system bus 1108 through interfaces such as a video adapter 1146, and the like. In addition to the monitor 1144, the computer generally includes other peripheral output devices (not illustrated) such as a speaker, a printer, others.

The computer 1102 may operate in a networked environment by using a logical connection to one or more remote computers including remote computer(s) 1148 through wired and/or wireless communication. The remote computer(s) 1148 may be a workstation, a computing device computer, a router, a personal computer, a portable computer, a micro-processor based entertainment apparatus, a peer device, or other general network nodes and generally includes multiple components or all of the components described with respect to the computer 1102, but only a memory storage device 1150 is illustrated for brief description. The illustrated logical connection includes a wired/wireless connection to a local area network (LAN) 1152 and/or a larger network, for example, a wide area network (WAN) 1154. The LAN and WAN networking environments are general environments in offices and companies and facilitate an enterprise-wide computer network such as Intranet, and all of them may be connected to a worldwide computer network, for example, the Internet.

When the computer 1102 is used in the LAN networking environment, the computer 1102 is connected to a local network 1152 through a wired and/or wireless communication network interface or an adapter 1156. The adapter 1156 may facilitate the wired or wireless communication to the LAN 1152 and the LAN 1152 also includes a wireless access point installed therein in order to communicate with the wireless adapter 1156. When the computer 1102 is used in the WAN networking environment, the computer 1102 may include a modem 1158 or has other means that configure communication through the WAN 1154 such as connection to a communication computing device on the WAN 1154 or connection through the Internet. The modem 1158 which may be an internal or external and wired or wireless device is connected to the system bus 1108 through the serial port interface 1142. In the networked environment, the program modules described with respect to the computer 1102 or some thereof may be stored in the remote memory/storage device 1150. It will be well known that an illustrated network connection is exemplary and other means configuring a communication link among computers may be used.

The computer 1102 performs an operation of communicating with predetermined wireless devices or entities which are disposed and operated by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and Bluetooth wireless technology. Accordingly, communication may be a predefined structure like the network in the related art or just ad hoc communication between at least two devices.

The wireless fidelity (Wi-Fi) enables connection to the Internet, and the like without a wired cable. The Wi-Fi is a wireless technology such as the device, for example, a cellular phone which enables the computer to transmit and receive data indoors or outdoors, that is, anywhere in a communication range of a base station. The Wi-Fi network uses a wireless technology called IEEE 802.11 (a, b, g, and others) in order to provide safe, reliable, and high-speed wireless connection. The Wi-Fi may be used to connect the computers to each other or the Internet and the wired network (using IEEE 802.3 or Ethernet). The Wi-Fi network may operate, for example, at a data rate of 11 Mbps (802.11a) or 54 Mbps (802.11b) in unlicensed 2.4 and 5 GHz wireless bands or operate in a product including both bands (dual bands).

It will be appreciated by those skilled in the art that information and signals may be expressed by using various different predetermined technologies and techniques. For example, data, instructions, commands, information, signals, bits, symbols, and chips which may be referred in the above description may be expressed by voltages, currents, electromagnetic waves, magnetic fields or particles, optical fields or particles, or predetermined combinations thereof.

It may be appreciated by those skilled in the art that various exemplary logical blocks, modules, processors, means, circuits, and algorithm steps described in association with the exemplary embodiments disclosed herein may be implemented by electronic hardware, various types of programs or design codes (for easy description, herein, designated as software), or a combination of all of them. In order to clearly describe the inter compatibility of the hardware and the software, various exemplary components, blocks, modules, circuits, and steps have been generally described above in association with functions thereof. Whether the functions are implemented as the hardware or software depends on design restrictions given to a specific application and an entire system. Those skilled in the art of the present disclosure may implement functions described by various methods with respect to each specific application, but it should not be interpreted that the implementation determination departs from the scope of the present disclosure.

Various exemplary embodiments presented herein may be implemented as manufactured articles using a method, a device, or a standard programming and/or engineering technique. The term manufactured article includes a computer program, a carrier, or a medium which is accessible by a predetermined computer-readable storage device. For example, a computer-readable storage medium includes a magnetic storage device (for example, a hard disk, a floppy disk, a magnetic strip, or the like), an optical disk (for example, a CD, a DVD, or the like), a smart card, and a flash memory device (for example, an EEPROM, a card, a stick, a key drive, or the like), but is not limited thereto. Further, various storage media presented herein include one or more devices and/or other machine-readable media for storing information.

It will be appreciated that a specific order or a hierarchical structure of steps in the presented processes is one example of exemplary accesses. It will be appreciated that the specific order or the hierarchical structure of the steps in the processes within the scope of the present disclosure may be rearranged based on design priorities. Appended method claims provide elements of various steps in a sample order, but the method claims are not limited to the presented specific order or hierarchical structure.

The description of the presented exemplary embodiments is provided so that those skilled in the art of the present disclosure use or implement the present disclosure. Various modifications of the exemplary embodiments will be apparent to those skilled in the art and general principles defined herein can be applied to other exemplary embodiments without departing from the scope of the present disclosure. Therefore, the present disclosure is not limited to the exemplary embodiments presented herein, but should be interpreted within the widest range which is coherent with the principles and new features presented herein.

### MODE FOR CARRYING OUT THE INVENTION

Related contents in the best mode for carrying out the present disclosure are described as above.

### INDUSTRIAL APPLICABILITY

The present disclosure may be used in a quantum computing device, a quantum computing system, etc., for generating a qubit.

1. A quantum computing platform comprising:
a magnet having a space formed therein;
a bar inserted into an interior of the magnet, and containing a material capable of state transition;
a gradient coil provided inside the magnet and generating a gradient inside the magnet;
a first RF coil placed between the bar and the gradient coil, and applying a first radio frequency (RF) pulse to the interior of the magnet; and
at least one second RF coil placed between the bar and the first RF coil, applying a second RF pulse to the interior of the magnet, and generating a qubit by using the bar.

2. The quantum computing platform of claim 1, wherein the material contains a nuclide having a nuclear spin of ½.

3. The quantum computing platform of claim 1, wherein the material includes a hydrogen atomic nucleus.

4. The quantum computing platform of claim 1, wherein the first RF pulse and the second RF pulse have different angles.

5. The quantum computing platform of claim 1, wherein when there are a plurality of second RF coils, the plurality of second RF coils are placed to be spaced apart from each other.

6. The quantum computing platform of claim 5, wherein the plurality of second RF coils are placed to be spaced apart from each other to correspond to a predetermined distance.

7. The quantum computing platform of claim 1, wherein when there are a plurality of second RF coils, the plurality of second RF coils have different frequencies.

8. The quantum computing platform of claim 1, wherein when there are the plurality of second RF coils, each of the plurality of second RF coils generates the qubit.

9. The quantum computing platform of claim 1, wherein the qubit determines a probability of each of a ‘0’ state and a ‘1’ state based on a selected time.

10. The quantum computing platform of claim 9, wherein the ‘0’ state corresponds to an equilibrium state, and
the ‘1’ state corresponds to an excited state of the material.

11. The quantum computing platform of claim 1, wherein the qubit is a signal generated according to a spin echo phenomenon that is expressed when the second RF pulse at a different angle from the first RF pulse is applied to the bar from at least one second RF coil.

12. The quantum computing platform of claim 11, wherein the first RF pulse has an angle of 90 degrees, and the second RF pulse has an angle of 180 degrees.

13. A method for generating a qubit, comprising:
by a first RF coil placed between a bar inserted into an interior of a magnet having a space formed therein and a gradient coil generating a gradient inside the magnet, applying a first RF pulse to the interior of the magnet; and
by a second RF coil placed between the bar and the first RF coil, applying a second RF pulse to the interior of the magnet and generating a qubit by using the bar.
